(19) United States
(12) Patent Application Publication
(10) Pub. No.: US 2021/0136127 A1
(43) Pub. Date: May 6, 2021

(54) Teleconferencing Device Capability Reporting and Selection

(71) Applicant: Microsoft Technology Licensing, LLC, Redmond, WA (US)

(72) Inventors: Arash Ghanaie-Sichanie, Woodinville, WA (US); Senthil Velayutham, Seattle, WA (US); Timur Aleshin, Philadelphia, PA (US); Ross Cutler, Duvall, WA (US)

(73) Assignee: Microsoft Technology Licensing, LLC, Redmond, WA (US)

(21) Appl. No.: 16/745,307

(22) Filed: Jan. 16, 2020

Related U.S. Application Data
(60) Provisional application No. 62/929,683, filed on Nov. 1, 2019.

(51) Int. Cl. H04L 29/06

(52) U.S. Cl. CPC H04L 65/1093; H04L 65/403; H04L 65/601

(57) ABSTRACT

Techniques for conducting a communication session include obtaining capabilities of a set of one or more first devices and a second device configured to provide content to the first devices, the second device being configured to generate a plurality of data streams associated with the communication session; sending a first signal over a network to the second device to configure one or more operating parameters of the second device to generate the one or more data streams according to the capabilities of the first devices; and dynamically updating the operating parameters of the second device to alter the one or more data streams generated by the second device responsive to receiving an indication of changes in the capabilities of one or more of the first devices, a set of one or more third devices joining the communication session having different capabilities than the first set of devices, or both.

### CROSS-REFERENCE TO RELATED APPLICATION

This application claims the benefit of priority to a provisional patent application under 35 U.S.C. § 119 to U.S. Provisional Patent Application No. 62/929,683, filed on Nov. 1, 2019 and entitled “Teleconferencing Device Capability Reporting and Selection,” the entirety of which is incorporated by reference herein in its entirety. This application is related to U.S. patent application Ser. No. 16/672,200, filed on Nov. 1, 2019 and titled “Automatic Detection Of Presentation Surface and Generation of Associated Data Stream,” and to U.S. patent application Ser. No. 16/672,265, filed on Nov. 1, 2019 and titled “Throttling and Prioritization for Multichannel Audio and/or Multiple Data Streams for Conferencing.” The entire contents of the above-referenced applications are incorporated herein by reference.

### BACKGROUND

Teleconferencing systems provide users with the ability to conduct productive meetings while located at separate locations. Teleconferencing systems may capture audio and/or video content of an environment in which the meeting is taking place to share with remote users and may provide audio and/or video content of remote users so that meeting participants can more readily interact with one another. There are significant areas for new and approved mechanisms for facilitating more immersive and productive meetings.

### SUMMARY

An example data processing system according to a first aspect of the invention include a processor; and a computer-readable medium. The computer-readable medium stores executable instructions for causing the processor to perform operations comprising obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices; sending a first signal over a network to the second device to configure one or more operating parameters of the second device to generate the one or more data streams according to the capabilities of the set of one or more first devices; and dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

An example method executed by a data processing system for conducting a communication session according to a second aspect of the invention includes: obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices; sending a first signal over a network to the second device to configure one or more operating parameters of the second device to generate the one or more data streams according to the capabilities of the set of one or more first devices; and dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

An example memory device according to a third aspect of the invention stores instructions that, when executed on a processor of a computing device, cause the computing device to conduct a communication session, by: obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices; sending a first signal over a network to the second device to configure one or more operating parameters of the second device to generate the one or more data streams according to the capabilities of the set of one or more first devices; and dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 presents an example environment in which a communication session according to the techniques disclosed herein may be used;

FIG. 2 is a diagram that an example source device and the console, such as those illustrated in FIG. 1;

FIG. 3 illustrates details of an example cloud service;

FIG. 4 is a flow diagram of an example process for conducting a communication session;

FIG. 5 is a block diagram illustrating an example software architecture, various portions of which may be used in conjunction with various hardware architectures herein described, which may implement any of the features herein described; and

FIG. 6 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques that may be implemented by a server configured to facilitate communication sessions between source devices and receiver devices are provided. A source device is a device that is configured to capture audio and/or video content associated with a communication session and to generate a plurality of media streams based on the audio and/or video content to be provide to the receiver devices associated with the communication session. In some implementations, a receiver device may also be configured to operate as a source device, and/or a source device may also be configured to operate as a receiver device.

Generating the various media streams produced by the source device may require significant amounts of processing resources and transmitting the various media streams generated by the source device may require significant amounts of bandwidth. Simply transmitting all of the types of media streams that source device is capable of transmitting is an inefficient use of processing and network resources without receiver devices that can utilize all of these types of media stream. The techniques disclosed herein provide a solution to this problem by providing for more efficient usage of processing and network resources in a communication session.

The techniques disclosed herein can be used to dynamically determine the capabilities of the receiver devices participating in a communication session and to configure operating parameters of a source device to generate one or more media streams based on the capabilities of the receiver devices. The capabilities of the source device and/or the receiver devices may change during the communication session. For example, additional receiver devices may join the communication session that have different capabilities than the receiver devices that are already participating in the communication session. The server can assess the capabilities of the additional receiver devices to determine whether these devices are capable of processing additional types of media streams that are not currently being generated by the source device and can reconfigure the source device to produce these additional types of media streams. The receiving capabilities of the receiver devices may also change during the communication session in response to changing operating conditions of one or more of the receiver devices. For example, a receiver device may experience a bandwidth limitation reduces the bandwidth available to the receiver device for receiving content associated with the communication session, and the server may dynamically configure one or more operating parameters of the source device to generate one or more lower bandwidth media streams for the receiver device. Similarly, the server may dynamically configure one or more operating parameters of the source device to generate a higher quality, high bandwidth media stream for a receiver device that becomes able to process such a higher quality data stream during the communication session. The capabilities of a source device may also change during the communication session. A bandwidth limitation may be experienced by the device and/or one or more peripheral devices configured to capture audio, images, and/or video may be associated with the source device during the communication session. The examples that follow illustrate these concepts.

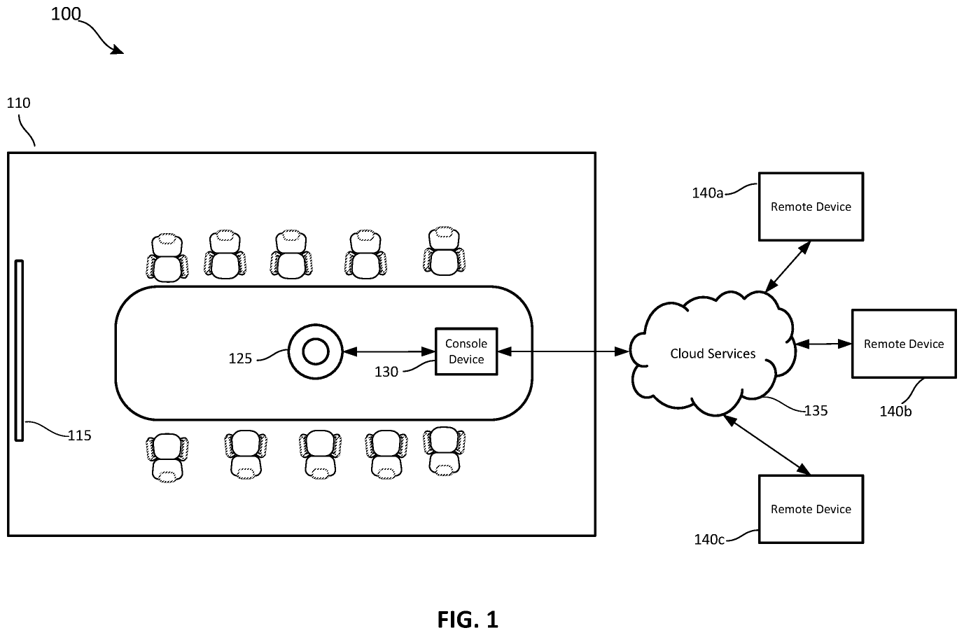

FIG. 1 presents an example environment 110 in which a communication session may be may take place. The environment 110 may be a meeting room or other area dedicated to conducting meetings, as in the example environment 110 illustrated in FIG. 1 or may be another space in which at least one participant may be physically present and in which the conferencing system components may be located. The conferencing system in this example includes a source device 125 (also referred to herein as a “endpoint device”), and a console device 130. In the example implementation illustrated in FIG. 1, there is a single source device 125 communicably coupled with the console 130. In other implementations, multiple source devices may be present in the environment from which the communication session is being conducted. One or more remote devices, such as the remote device 140a-140c, may be associated with the conferencing system and provide a user interface that enables remote participants to a communication session to receive one or more media streams associated with the communication session from the source device 125.

The console device 130 is communicably coupled to the cloud services 135 via one or more wired and/or wireless network connections. The cloud services 135 may comprise one or computer servers that are configured to facilitate various aspects of a communication session. The cloud services 135 may be configured to coordinate the scheduling and execution of a communication session. The cloud services 135 may be configured to facilitate routing media streams provided by source devices, such as the source device 125, to receiver devices, such as the remote devices 140a-140c.

While the source device 125 is illustrated as a desktop or tabletop computing device in the example embodiments disclosed herein, the source device 125 is not limited to such a configuration. In some implementations, the functionality of the console device 130 may be combined with that of the source device 125 into a single device. The functionality of the source device 125 may be implemented as a portable electronic device, such as a mobile phone, a tablet computer, a laptop computer, a portable digital assistant device, a portable game console, and/or other such devices. The source device 125 may also be implemented in computing devices having other form factors, such as a vehicle onboard computing system, a video game console, a desktop computer, and/or other types of computing devices.

The remote devices 140a-140c are computing devices that may have the capability to present one or more type of media stream provided by the source device 125, such as media streams that comprise audio, video, images, text content, and/or other types of media stream. Each of the remote devices 140a-140c may have different capabilities based on the hardware and/or software configuration of the respective remote device. While the example illustrated in FIG. 1 includes three remote devices, a communication session may include fewer than three remote devices or may include more than three remote devices. The remote devices 140a-140c may be implemented as a portable electronic device, such as a mobile phone, a tablet computer, a laptop computer, a portable digital assistant device, a portable game console, and/or other such devices. The remote devices 140a-140c may also be implemented in computing devices having other form factors, such as a vehicle onboard computing system, a video game console, a desktop computer, and/or other types of computing devices.

The environment 110 also includes a whiteboard 115 which includes a presentation surface upon which participants of the meeting may take notes, draw diagrams, sketch ideas, and/or capture other information related to the communication session. While the example illustrated in FIG. 1 includes a whiteboard, the source device 125 may be configured to detect and capture a media stream for other types of presentation surfaces, such as a note pad or other object that includes a presentation surface. In some implementations, the whiteboard or other presentation surface may be in a fixed location similar to the whiteboard 115 illustrated in FIG. 1. In other implementations, the whiteboard or other presentation surface may not have a fixed location. For example, a whiteboard or notepad may be placed on an easel or stand that may be moved to different locations within the environment in which the communication session takes place. A notepad, note paper, or other similar presentation surface may rest on a conference room table or other such surface. Some implementations may not include such a presentation surface that may be detected by the source device 125 and included as a media stream in a communication session.

The cloud services 135 may be configured to monitor the source device 125 and receiver devices, such as the remote devices 140a-140c, to determine the capabilities of the devices participating in a communication session. The cloud services 135 may dynamically configure one or more operating parameters of the source device 125 to control which media streams the source device 125 is generated for the communication session. The capabilities of the source device 125 and the receiver devices may change during the communication session, and the cloud services 135 may dynamically determine which media streams the source device 125 should generate based on the current capabilities of the source device 125 and the receiver devices. The cloud services 135 can take into account various factors, such as changes in network bandwidth, changes in the available peripheral devices for capturing media by the source device 125, and changes in the configuration of the receiving devices. The cloud services 135 may also be configured to generate one or more media streams for a communication session based on one or more media streams generated by the source device 125. The cloud services 125 may generate the one or more media streams in response to limited bandwidth and/or processing power of the source device 125. The examples which follow provide further details of the source device 125 and the cloud services 135.

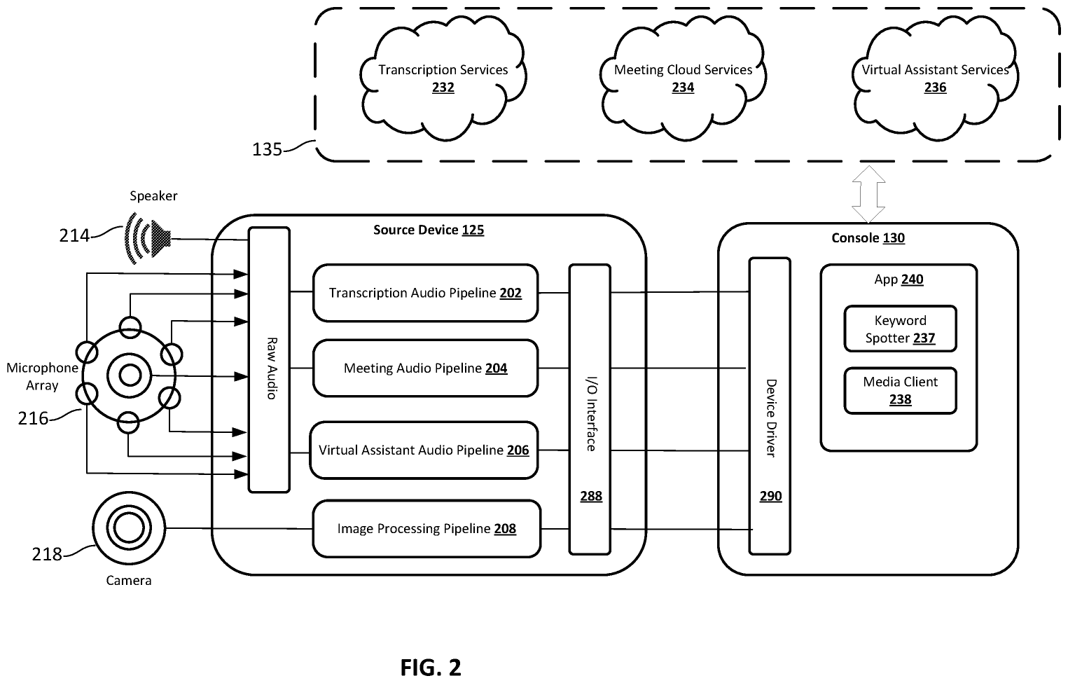

FIG. 2 is a diagram that provides additional details of the source device 125, the console 130, and the cloud services 135. The source device 125 is configured to capture audio and/video signals to generate media streams that may be processed by the source device 125, the console 130, the cloud services 135, or a combination thereof. The cloud services 135 may process the media streams further as will be discussed in the examples that follow and/or may selectively route one or more media streams to the receiver devices 140a-140c. The source device 125 illustrated in FIG. 2 includes three audio pipelines for processing audio captured by the source device 125, including a transcription audio pipeline 202, a meeting audio pipeline 204, and a virtual assistant audio pipeline 206. The source device 125 also includes an image processing pipeline 208 for processing images and video content. The audio and image processing pipelines of the example implementation of FIG. 2 are intended to illustrate some of the types of audio and/or image processing that the source device 125 may perform to produce various types of media streams for a communication session. Other types of processing pipelines may be included in other implementations of the source device in addition to or instead of one or more of the processing pipelines in this example implementation. Furthermore, the source device 125 is discussed as being configurable to produce various types of media streams that may be provided to the cloud services 135 and/or to the receiver devices participating in a communication session. The media streams discussed herein are intended to illustrate examples of some of the types of media streams that may be generated by the source device 125. Other implementations may be configured to generate other types of media streams in addition to or instead of one or more of the media streams discussed in this example.

The source device 125 may include a speaker 214, a microphone array 216, and a camera 218. The source device 125 may be configured to output audio content associated with the communication session via the speaker 214. The audio content may include speech from remote participants and/or other audio content associated with the communication session. The microphone array 216 includes a plurality of microphones that may be used to capture audio from the environment in which the communication session occurs. The use of a microphone array to capture audio may be used to obtain multiple audio signals that can be used to determine directionality of a source of audio content. The audio signals output by the microphone array 216 may be analyzed by the endpoint 125, the console 130, the cloud services 135, or a combination thereof to provide various services which will be discussed in greater detail in the examples which follow. The camera 218 may be a 360-degree camera that is configured to capture a panoramic view of the environment in which the communication session occurs. The output from the camera 218 may need to be further processed by the image processing pipeline 208 to generate the panoramic view of the environment in which the source device 125 is located. The source device 125 may also be connected additional microphone(s) for capturing audio content and/or additional camera(s) for capturing images and/or video content. The audio quality of the additional microphone(s) may be different from the audio quality of the microphone array 216 and may provide improved audio quality. The image quality and/or the video quality provided by the additional camera(s) may be different from the image quality and/or the video quality provided by the camera 218. The additional camera(s) may provide improved image quality and/or video quality. Furthermore, the additional cameras may be 360-degree cameras or may have an field of view (FOV) that is substantially less than 360 degrees.

The source device 125 may be configured to process audio content captured by the microphone array 216 in order to provide various services in relation to the communication session. In the example illustrated in FIG. 2, the source device 125 includes audio pipelines for processing audio inputs to produce audio-based media streams and an image processing pipeline to produce image-based and/or video-based media streams. Some implementations of the source device 125 may only be capable of producing audio-based media streams, while other implementations may be capable of producing both audio-based and image-based and/or video-based media stream.

The source device 125 may include a transcription audio pipeline 202. The transcription audio pipeline 202 may be configured to process audio captured by the microphone array to facilitate automated transcriptions of communications sessions. The transcription audio pipeline 202 may perform pre-processing on audio content from the microphone array 216 and send the processed audio content to the transcription services 232 of the cloud services 135 for processing to generate a transcript of the communication session. The transcript of the communication session may provide a written record what is said by participants physically located in the environment at which the communication session occurs and may also include what is said by remote participants using the remote devices 140a-140c. The remote participants of the communication session may be participating on a computing device that is configured to capture audio content and is configured to route the audio content to the transcription services 232 and/or the other cloud services 135. The transcription services 232 may be configured to provide diarized transcripts that not only include what was said in the meeting but who said what. The transcription services 232 can use the multiple audio signals captured by the microphone array 216 to determine directionality of audio content received by the microphone array 216. The transcription services 232 can use these signals in addition to other signals that may be provided by the source device 125 and/or the console 130 to determine which user is speaking and record that information in the transcripts. In some implementations, the transcription audio pipeline 202 may be configured to encode the audio input received from the microphone array using the Free Lossless Audio Codec (FLAC) which provides lossless compression of the audio signals received from the microphone array 216.

The source device may include a meeting audio pipeline 204. The meeting audio pipeline 204 may process audio signals received from the microphone array 216 for generation of audio streams to be transmitted to remote participants of the communication session and for Voice over IP (VOIP) calls for participants who have connected to the communication session via a VOIP call. The audio pipeline 204 may be configured to perform various processing on the audio signals received from the microphone array 216, such as but not limited to gain control, linear echo cancellation, beamforming, echo suppression, and noise suppression. The output from the meeting audio pipeline 204 may be routed to the meeting cloud services 234, which may perform additional processing on the audio signals. The meeting cloud services 234 may also coordinate sending audio-based, image-based. and/or video-based media streams captured by the source device 125 and/or by the computing devices of one or more remote participants to other participants of the communication session. The meeting cloud services 234 may also be configured to store content associated with communication session, such as audio and video streams, participant information, transcripts, and other information related to the communication session.

The source device 125 may include a virtual assistant audio pipeline 206. The virtual assistant audio pipeline 206 may be configured to process audio signals received from the microphone array 216 to optimize the audio signal for automated speech recognition (ASR) processing by the virtual assistant services 236. The source device 125 may transmit the output of the virtual assistant audio pipeline 206 to the virtual assistant services 236 for processing via the console 130. The virtual assistant audio pipeline 206 may be configured to recognize a wake-word or phrase associated with the virtual assistant and may begin transmitting processed audio signals to the virtual assistant services 236 in response to recognizing the wake-word or phrase. The virtual assistant services 236 may provide audio responses to commands issued to via the source device 125 and the responses may be output by the speaker 214 of the source device 125 and/or transmitted to the computing devices of remote participants of the communication session. The participants of the communication session may request that the virtual assistant perform various tasks, such as but not limited to inviting additional participants to the communication session, looking up information for a user, and/or other such tasks that the virtual assistant is capable of performing on behalf of participants of the communication session.

The source device 125 may include an image processing pipeline 208. The image processing pipeline 208 may be configured to process signals received from the camera 218. The image processing pipeline 208 may be configured to perform panorama stitching. The camera 218 may be a 360 degrees camera capable of capturing images and/or video of an area spanning 360 degrees around the camera. The camera 218 may comprise multiple lenses and image sensors and the image processing pipeline 208 may be configured to stitch together the output of each of the images sensors to produce panoramic view of the area surrounding the camera 218.

The camera 214 may include multiple lenses and/or sensors to capture multiple images and/or video of the environment in which the communication session is taking place and image processing pipeline 208 may be configured to stitch together the multiple overlapping images and/or video captured by camera 214 to produce a substantially 360 view of the environment. The source device 125 may be configured to generate one or more media streams based on the panoramic images and/or video of the environment in which the source device 130 is located. For example, dedicated media streams for each participant present in the environment 110, and/or for the writing surface 115 or other object detected in the environment may be generated by the image processing pipeline 208.

While FIG. 2 illustrates the source device 125 including a single camera, the source device 125 may be associated with a plurality of cameras. The plurality of cameras may provide varying levels of fidelity. In some implementations, a camera may be lower resolution web camera capable of capturing lower resolution images and/or video, in other implementations the camera may be a high-resolution camera capable of capturing high definition images and/or video. For example, a low-resolution video camera may be capable of supporting Video Graphics Array (VGA) 640×480 resolution, while a high-resolution video camera may be capable of supporting 4K Ultra High Definition (UHD) digital format. Other digital formats may be supported by the camera or cameras associated with the source device 125. The source device 125 may be configured to switch one or more cameras on or off as needed. The source device 125 may be configured to switch one or more cameras off responsive to the receiver devices participating in a communication session not being capable of processing image-based and/or video-based image streams output based on the output of the one or more cameras or not having sufficient bandwidth available to handle such media streams. However, if the configuration of a receiver device changes during the communication session and/or at least one additional receiver device joins the communication session and is capable of supporting the images-based and/or video-based output of the camera or cameras that have been switched off, the server can change the operating parameters of the source device 125 to switch the camera or cameras back on and the image processing pipeline 208 can begin generating a one or more media streams based on the image-based and/or video-based output from the cameras.

The source device 125 may also be associated with one or more additional microphones in addition to the microphone array 216. The additional microphones may be standalone microphones or microphone arrays. The additional microphones may be capable of producing audio output of varying levels of quality and the quality audio output of the additional microphones may be different than that of the microphone array 216. The source device 125 may be configured to switch one or more microphones off responsive to the receiver devices participating in a communication session not being capable of processing audio-based media streams output based on the output of the one or more microphones. The source device 125 may also be configured to switch off the one or more additional microphones where the source device is experiencing a bandwidth limitation and must prioritize which media streams to determine which media streams may be transmitted in the limited bandwidth available and/or whether to throttle a data rate of one or more media streams to reduce the bandwidth requirements of the source device 125.

The console 130 may comprise a computing device that may serve as a communication relay between the source device 125 and the cloud services 135. The source device 125 may include an input/output (I/O) interface that provides a wired and/or wireless connection between the source device 125 and the console 130. In some implementations, the I/O interface may comprise a Universal Serial Bus (USB) connector for communicably connecting the source device 125 with the console 130. In some implementations, the console may comprise a general-purpose computing device, such as a laptop, desktop computer, and/or other computing device capable of communicating with the end point device 125 via one or more device drivers. The console 130 may include an application 240 that is configured to relay data between the source device 125 and the cloud services 135. The application 240 may comprise a keyword spotter 237 and a media client 238. The keyword spotter 237 may be configured to recognize a wake word or a wake phrase that may be used to initiate a virtual assistant, such as but not limited to Microsoft Cortana.

The media client 238 may be configured to provide a user interface that allows users to control one or more operating parameters of the source device 125. For example, the media client 238 may allow a user to adjust the volume of the speaker 214, to mute or unmute the microphone array 216, to turn the camera 218 on or off, and/or control other operation parameters of the source device 125. The media client 238 may also provide an API that allows the media client 238 to communicate with the cloud services 135. The meeting cloud services 135 may send configuration commands to the media client 238 to change one or more operating parameters of the source device 125.

Muting the microphone array 216 causes the remote participants to be unable to hear what is occurring in the conference room or other environment in which the communication session is based. Turning off the camera 218 will halt the generation of individual media streams for each of the participants in the conference room or other environment and other media streams of the environment so that remote participants will be unable to see what is occurring in the conference room or environment in which the communication session is based. The media client 238 may also enable a user to turn on or off the transcription facilities of the conferencing system, and to turn on or turn off recording of audio and/or video of the communication session.

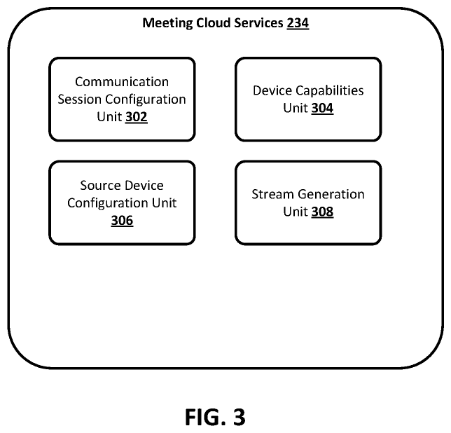

FIG. 3 is a block diagram of functional components of an example implementation of the meeting cloud services 234. FIG. 3 illustrates some of the functional components of the meeting cloud services 234. The meeting cloud services 234 may be implemented by one or more servers associate with the cloud services 135.

The cloud meeting cloud services 234 may include a communication session configuration unit 302, a device capabilities unit 304, a source device configuration unit 306, and a stream generation unit 308. The meeting cloud services 234 may include other functional components that have been omitted for the sake of clarity.

The communication session configuration unit 302 may be configured to facilitate establishment of a communication session and management of resources associated with the communication session. The communication session configuration unit 302 may be configured to provide a user interface that may be rendered in a web browser or other similar application that can render web-based content. The user interface may permit a user to set up a new communication session, schedule the communication session if the communication session is not to begin immediately, invite participants to the communication sessions, to upload files and/or other content that may be shared with other users during the communication session, and/or perform other actions related to establishing and conducting the communication session. The user interface may also be configured to render one or more media streams associated with the communication session on a display of the computing device of the participate accessing the communication session via the web-based user interface. The communication session configuration unit 302 may provide an application programming interface (API) that provides an interface for an application on a computing device, such as the remote devise 140a-140c, the source device 125, the console 130, and/or other computing devices that may participate in the communication session. The API may facilitate the exchange of data between the application on the participant's device and the meeting cloud service 234. The API may facilitate the sending of one or more media streams to the participant's computing device and/or receiving one or more media streams from the participant's computing device.

A user who is setting up the communication session may specify in advance which device or devices may serve as the source device(s) for the communication session. For example, the user may specify a location in which participants who are physically present for the communication session may meet, such as the environment 110 illustrated in FIG. 1. In other implementations, the source device(s) may not be determined until the communication session commences and the source device(s) and the receiver device(s) establish a connection to the meeting cloud services 234.

The device capabilities unit 304 may be configured to determine the device capabilities of the receiver devices, such as the remote devices 140a-140c, and the source devices, such as the source device 125. The device capabilities unit 304 may send a signal to each device participating in a communication session to obtain the capabilities of the device. The device capabilities of the receiver devices may represent the ability of the hardware and/or software of the receiver device to receive and output on a user interface of the receiver device one or more types of media stream provided by the source device 125, such as media streams that comprise audio-based, video-based, image-based, text-based, and/or other types of media stream. Each of the receiver devices participating in a communication session may have different capabilities based on the hardware and/or software configuration of the respective receiver device. The capabilities of the source device 125 may represent the ability of the hardware and/or software of the source device 125 to produce one or more types of media stream, which may comprise audio-based, video-based, image-based, text-based, and/or other types of media stream. The meeting cloud services 234 may maintain a catalog of the capabilities of the source device(s) and receiver device(s) participating in a communication session and may dynamically update that catalog of capabilities in response to changes in the capabilities of one or more of the participating devices.

The source device 125 and the receiver devices may be configured to send a signal to the meeting cloud services 234 in response to the device detecting a change in the capabilities of the device. With respect to the source device 125, the source device 125 may be configured to detect that changes to the ability to source device 125 to capture audio, image, and/or video content may have changed. Such a change may result from an additional peripheral device configured to capture audio, image, and/or video being added to the source device 125 during to the communication session. For example, a participant located in the environment 110 in which the communication session is based may activate a new camera or cameras, microphone or microphones, or other peripheral devices associated with the source device 125 during the communication session. These devices may be communicably connected with the source device 125 via wired and/or wireless connections. The source device 125 may report the availability of these devices to the meeting cloud services 234, and the meeting cloud services 234 may add these capabilities to the catalog of device information associated with the devices participating in the communications session. The meeting cloud services 234 may also assess whether one or more of the receiver devices are capable of receiving content associated with the newly added devices and may configure one or more operating parameters of the source device 125 to cause the source device 125 produce one or more media streams associated with the output of the newly added devices.

The source device 125 may also receive an indication of a bandwidth limitation that reduces the bandwidth available to the source device 125 for transmitting media streams associated with the communication session. The source device 125, the cloud services 135, and/or the receiver devices, such as remote devices 140a-140c, may each be configured to monitor for bandwidth decreases associated with one or more communication links that these respective devices use for transmitting and/or receiving data associated with the communication session. The source device 125 and the receiver devices may report such a bandwidth decrease to the meeting cloud services 234, and the meeting cloud services 234 may prioritize the media streams produced by the source device 125 to maximize the available bandwidth and the meeting cloud services 234 may generate one or media additional streams for the receiver devices based on the media streams that the source device 125 is able to provided using the limited bandwidth available.

With respect to a capability change in a receiver device, the receiver device may be configured to detect that changes to the ability receive and/or present audio, image, and/or video content associated with the communication session has changed and to send a signal to the meeting cloud services 234 identifying the changes in capabilities of the receiver device. For example, a receiver device may experience a bandwidth limitation that reduces the available bandwidth for receiving media streams associated with the communication session. The meeting cloud services 234 may receive an indication from the receiver device that the available bandwidth for the receiver device has decreased since the communication session has commenced, and the meeting cloud services 234 may configure the operating parameters of the source device 125 to produce one or more lower-bandwidth media streams for the receiver device. The one or more lower-bandwidth media streams may be generated based on the one or more higher-bandwidth data streams currently being produced by the source device 125. The source device 125 may generate and provide both the lower-quality and the higher-quality data streams to the cloud services 135 and/or to one or more receiver devices. If the meeting cloud services 234 determines that none of the receiver devices nor the cloud services 135 require the one or more higher-bandwidth data streams in response to the receiver device providing the indication that the device capabilities have changed, then the meeting cloud services 234 may dynamically configure one or more operating parameters of the source device 125 to cause the source device 125 to stop producing the one or more higher-bandwidth media streams. Similarly, if a receiver device is reconfigured by a user to be able to receive one or more types of higher-bandwidth media stream and/or the receiver device is no longer experiencing a bandwidth limitation that reduces the available bandwidth for receiving content associated with the communication session, the server may dynamically reconfigure one or more operating parameters of the source device 125 to cause the source device 125 to start producing one or more higher-bandwidth data streams.

The source device configuration unit 306 may be configured to send a signal to the source device 125 to configure one or more parameters of the source device. In some implementations, the meeting cloud services 234 may change the operating parameters of the source device 125 by sending a signal indicating which operating parameters are to be changed to the media client 238 of the console 130. The media client 238 may then change the one or more operating parameters of the source device 125. In other implementations, the meeting cloud services 234 may send the signal to the source device 125 via the console 130, and the source device 125 may change the operating parameters according to the signal indicating which operating parameters are to be changed.

The stream generation unit 308 may be configured to generate one or more media streams based one or more media streams received from a source device 125. The stream generation unit 308 may be configured to generate one or more media streams 125 for the communication session and to send those media streams to one or more receiver devices, such as the remote devices 140a-140c. The stream generation unit 308 may be configured to determine that one or more receiver devices participating in a communication session are capable of processing a type of media stream that is not currently being generated by a source device 125 participating in the communication session. The stream generation unit 308 may determine, based on the capabilities of the source device 125, that the source device is not capable of producing a media stream of the required type or that the stream generation unit 308 is cable of generating but does not have sufficient processing resources to generate the media stream or sufficient bandwidth to transmit the media stream in addition to the one or more media streams already being generated by the source device 125. The stream generation unit 308 may be configured to determine that a media stream that is being generated by the source device 125 can be used to generate a media stream of the appropriate type for the receiver device.

The stream generation unit 308 may be configured to receive a high-quality audio, video, or image media stream from the source device 125 and to convert that media stream into a lower quality audio, video, or image media stream that is suitable for the playback capabilities of a particular receiver device. The receiver device may be unable to process the high-quality audio or video media stream due to hardware or software constrains of the receiver device or may be unable to receive such a high-quality audio or video media stream due to bandwidth constraints being experienced by the receiver device. The stream generation unit 308 may also be configured to generate a media stream of a different format for a particular receiver device in response to the receiver device being unable to process that format of media stream. For example, the source device may generate an AVI format media stream, and the stream generation unit 308 may convert the stream to an MPEG-4 format for delivery to one or more receiver devices. These media formats are just an example of media types that may be supported by devices participating in a communication session and one example of how the server may convert a media stream in one format into a media stream of a second format.

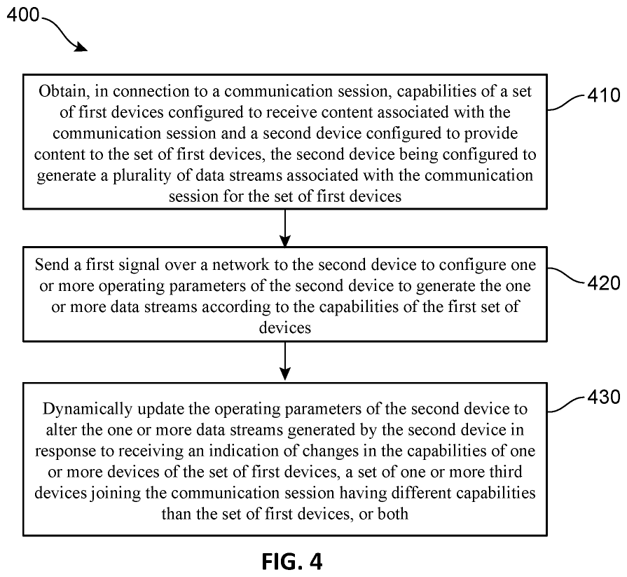

FIG. 4 is a flow diagram of an example process 400 for conducting a communication session including managing data streams sent by a source device during the communication session. The process 400 may be implemented a server of the cloud services 135. The process illustrated in FIG. 4 can be used dynamically modify one or more operating parameters of a source device 125 in response to detecting a change in device capabilities of receiver devices, such as remote devices 140a-140c, during the communication session.

The process 400 may include an operation 410 which includes obtaining, in connection to a communication session, capabilities of a set of one or more first devices configured to receive content associated with the communication session and a second device configured to provide content to the set of one or more first devices. The second device, which may be a source device such as the source device 125, is configured to generate a plurality of data streams associated with the communication session for the set of one or more first devices, such as the remote devices 140a-140c. The meeting cloud service 234 may be configured to receive device information from the source device and the receiver device(s) at the time that the devices join the communication session. In other implementations, the meeting cloud service 234 may send a signal comprising a request for capabilities from each of the devices participating in the communication session, and each device may send a signal to the meeting cloud service 234 comprising a device capabilities response that indicates the capabilities of the device. The device capabilities response from the receiver devices can indicate which types of media streams the receiver devices are configured to present to users of the receiver devices. The device capabilities response from the source device 125 can include which types of media streams the source device is capable of generating for the communication session.

The process 400 may include an operation 420 which includes sending a first signal to the second device to configure one or more operating parameters of the second device to generate the one or more data streams according to the capabilities of the set of one or more first devices. In some implementations, the meeting cloud services 234 may be configured to send a signal to the application 240 on the console 130 that includes configuration parameters for the source device 125. The configuration parameters may include one or more parameters to configure the source device 125 to generate one or more additional media streams that the source device 125 is not currently generating, one or more parameters to configure the source device 125 to stop generating one or more media streams that the source device 125 is currently generating, or both. The configuration parameters may result in the source device 125 activating one or more media capture components, such as microphones or cameras, deactivating one or more media capture components, or both. For example, the configuration parameters may configure the source device 125 to produce a high-quality audio-based media stream that may be produced by using a microphone or microphone array that is currently switched off because none of the receiver devices associated with the current communication session were capable of utilizing such a high-quality audio-based media stream. Similarly, the configuration parameters may configure the source device 125 to produce a high-quality image-based or video-based media stream that may be produced by a camera or set of cameras that are currently switched off because none of the receiver devices associated with the current communication session were previously capable of utilizing such a high-quality image-based or video-based media stream but are now capable of utilizing such a high-qualify media stream. The capabilities of the receiver device may have changed in response to a bandwidth limitation being resolved or due to the receiver device being reconfigured by a user of the receiver device.

The process 400 may include an operation 430 which includes dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of one or more first devices, or both. During a communication session, the capabilities of the receiver devices may change as additional devices join the communication session and/or the capabilities of receiving devise already participating in the communication session change. As discussed in the preceding examples, the capabilities of a receiver device may change during a communication session in response to the user reconfiguring one or more operating parameters of the receiver device or due to changes in the operating conditions of the receiver device. Furthermore, the capabilities of the source device may also change during the course of the communication session due to bandwidth limitations, and other factors as discussed in the preceding examples. The meeting cloud services 234 can dynamically reconfigure the operating parameters of the source device 125 to rapidly adapt to changes in the capabilities of the source device 125 and/or the receiver devices during the communication session to provide participants of the communication session with the best user experience possible in response to changing operating conditions.

Examples of the operations illustrated in the flow chart shown in FIG. 4 is described in connection with FIGS. 1-3. It is understood that the specific order or hierarchies of elements and/or operations disclosed in FIG. 4 are example approaches. Based upon design preferences, it is understood that the specific orders or hierarchies of elements and/or operations in FIG. 4 may be rearranged while remaining within the scope of the present disclosure. FIG. 4 presents elements of the various operations in sample orders and are not meant to be limited to the specific orders or hierarchies presented. Also, the accompanying claims present various elements and/or various elements of operations in sample orders and are not meant to be limited to the specific elements, orders, or hierarchies presented.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

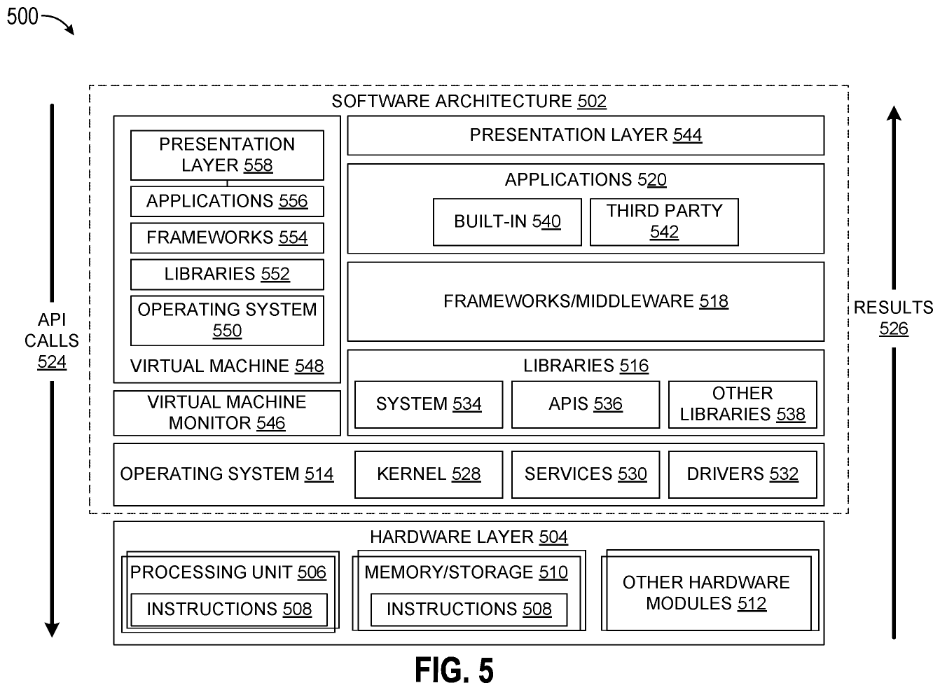

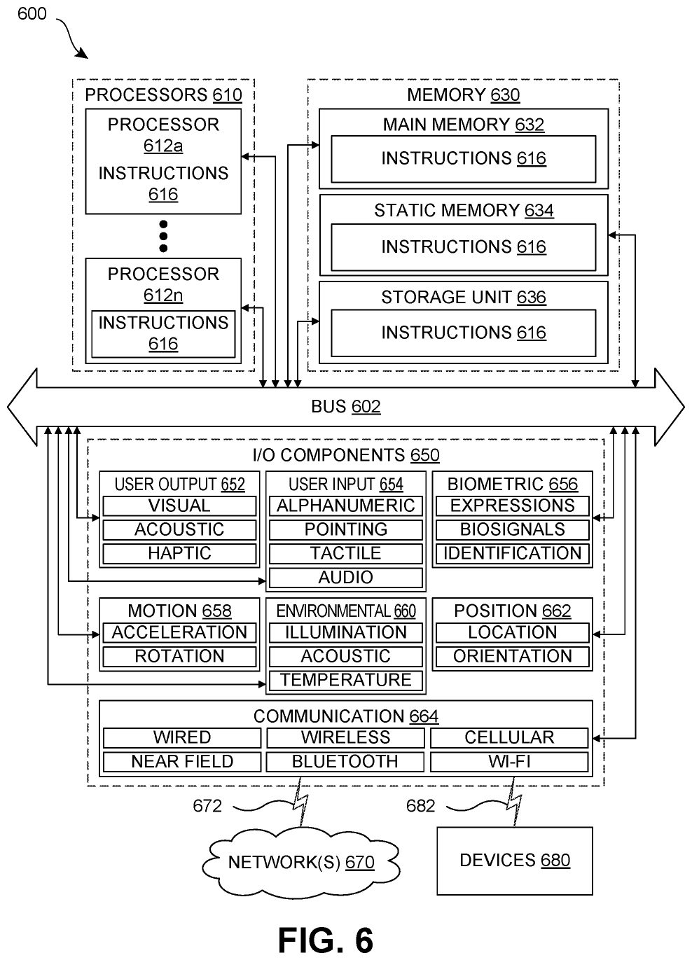

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 508 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 514, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

In the following, further features, characteristics and advantages of the system and method will be described by means of items: Item 1. A data processing system comprising: a processor; and a computer-readable medium storing executable instructions for causing the processor to perform operations comprising: identifying, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices; sending a first signal over a network to the second device to configure one or more operating parameters of the second device to generate the one or more data streams according to the capabilities of the set of one or more first devices; and dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

Item 2. The data processing system of item 1, wherein to dynamically update the operating parameters of the second device in response to one or more new devices joining the communication session the computer-readable medium further stores executable instructions for causing the processor to perform operations comprising: determining that the set of one or more third devices includes at least one device that has at least one capability to support at least one additional type of media stream that the second device is capable of generating for the communication session; and configuring the one or more operating parameters of the second device to cause the second device to generate the at least one additional type of media stream.

Item 3. The data processing system of item 1, wherein to dynamically update the operating parameters of the second device in response to receiving an indication of changes in the capabilities of one or more devices of the set of one or more first devices the computer-readable medium further stores executable instructions for causing the processor to perform operations comprising: determining that the set of one or more first devices includes at least one device that, due to a change in the capability of the at least one device, has at least one capability to support at least one additional type of media stream that the second device is capable of generating for the communication session; and configuring the one or more operating parameters of the second device to cause the second device to generate the at least one additional type of media stream.

Item 4. The data processing system of item 1, wherein to dynamically update the operating parameters of the second device in response to receiving an indication of changes in the capabilities of one or more devices of the set of one or more first devices the computer-readable medium further stores executable instructions for causing the processor to perform operations comprising: determining that none of the set of one or more first devices supports at least one type of media stream of the plurality of media streams being generated by the second device due to a change in capability of at least one device of the set of one or more first devices; and configuring the one or more operating parameters of the second device to cause the second device to stop generating the at least one type of media stream not supported by the set of one or more first devices.

Item 5. The data processing system of item 1, wherein to dynamically update the operating parameters of the second device to alter the one or more data streams the set of one or more first devices the computer-readable medium further stores executable instructions for causing the processor to perform operations comprising: sending a second signal over the network to the second device to change the configuration of one or more operating parameters to the second device to cause the second device to generate one or more additional types of media stream, to stop generating one or more types of media stream, or both.

Item 6. The data processing system of item 1, wherein to dynamically update the operating parameters of the second device to alter the one or more data streams the set of one or more first devices the computer-readable medium further stores executable instructions for causing the processor to perform operations comprising: determining that a device of the set of one or more first devices is capable of supporting a first type of media stream that the second device is capable of generating but is not currently being generating for the communication session; and determining, due to a bandwidth limitation, that the source device cannot provide the first type of media stream.

Item 7. The data processing system of item 6, wherein the computer-readable medium further stores executable instructions for causing the processor to perform operations comprising: determining that the first type of media stream can be generated from a second type of media stream currently being generated for the communication session; receiving the first type of media stream from the source device; generating the second type of media stream from the first type of media stream; and sending over the network the second type of media stream to the device of the set of one or more first devices capable of supporting the first type of media stream.

Item 8. A method by a data processing system for conducting a communication session, the method comprising: obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices; sending a first signal over a network to the second device to configure one or more operating parameters of the second device to generate the one or more data streams according to the capabilities of the set of one or more first devices; and dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

Item 9. The method of item 8, wherein dynamically updating the operating parameters of the second device in response to one or more new devices joining the communication session comprise: determining that the set of one or more third devices includes at least one device that has at least one capability to support at least one additional type of media stream that the second device is capable of generating for the communication session; and configuring the one or more operating parameters of the second device to cause the second device to generate the at least one additional type of media stream.

Item 10. The method of item 8, wherein dynamically updating the operating parameters of the second device in response to receiving an indication of changes in the capabilities of one or more devices of the set of one or more first devices: determining that the set of one or more first devices includes at least one device that, due to a change in the capability of the at least one device, has at least one capability to support at least one additional type of media stream that the second device is capable of generating for the communication session; and configuring the one or more operating parameters of the second device to cause the second device to generate the at least one additional type of media stream.

Item 11. The method of item 8, wherein dynamically updating the operating parameters of the second device in response to receiving an indication of changes in the capabilities of one or more devices of the set of one or more first devices: determining that none of the set of one or more first devices supports at least one type of media stream of the plurality of media streams being generated by the second device due to a change in capability of at least one device of the set of one or more first devices; and configuring the one or more operating parameters of the second device to cause the second device to stop generating the at least one type of media stream not supported by the set of one or more first devices.

Item 12. The method of item 8, wherein dynamically updating the operating parameters of the second device to alter the one or more data streams further comprises: sending a second signal over the network to the second device to change the configuration of one or more operating parameters to the second device to cause the second device to generate one or more additional types of media stream, to stop generating one or more types of media stream, or both.

Item 13. The method of item 8, wherein dynamically updating the operating parameters of the second device to alter the one or more data streams further comprises: determining that a device of the set of one or more first devices is capable of supporting a first type of media stream that the second device is capable of generating but is not currently being generating for the communication session; and determining, due to a bandwidth limitation, that the source device cannot provide the first type of media stream.

Item 14. The method of item 13, further comprising: determining that the first type of media stream can be generated from a second type of media stream currently being generated for the communication session; receiving the first type of media stream from the source device; generating the second type of media stream from the first type of media stream; and sending over the network the second type of media stream to the device of the set of one or more first devices capable of supporting the first type of media stream.

Item 15. A memory device storing instructions that, when executed on a processor of a computing device, cause the computing device to conduct a communication session, by: obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices; sending a first signal over a network to the second device to configure one or more operating parameters of the second device to generate the one or more data streams according to the capabilities of the set of one or more first devices; and dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

Item 16. The memory device of item 15, wherein to dynamically update the operating parameters of the second device in response to one or more new devices joining the communication session the memory device further stores executable instructions for causing the processor to perform operations comprising: determining that the set of one or more third devices includes at least one device that has at least one capability to support at least one additional type of media stream that the second device is capable of generating for the communication session; and configuring the one or more operating parameters of the second device to cause the second device to generate the at least one additional type of media stream.

Item 17. The memory device of item 15, wherein to dynamically update the operating parameters of the second device in response to receiving an indication of changes in the capabilities of one or more devices of the set of one or more first devices the memory device further stores executable instructions for causing the processor to perform operations comprising: determining that one or more devices of the set of first devices includes at least one device that, due to a change in the capability of the at least one device, has at least one capability to support at least one additional type of media stream that the second device is capable of generating for the communication session; and configuring the one or more operating parameters of the second device to cause the second device to generate the at least one additional type of media stream.

Item 18. The memory device of item 15, wherein to dynamically update the operating parameters of the second device in response to receiving an indication of changes in the capabilities of one or more devices of the set of one or more first devices the memory device further stores executable instructions for causing the processor to perform operations comprising: determining that none of the set of one or more first devices supports at least one type of media stream of the plurality of media streams being generated by the second device due to a change in capability of at least one device of the set of one or more first devices; and configuring the one or more operating parameters of the second device to cause the second device to stop generating the at least one type of media stream not supported by the set of one or more first devices.

Item 19. The memory device of item 15, wherein to dynamically update the operating parameters of the second device to alter the one or more data streams the set of one or more first devices the memory device further stores executable instructions for causing the processor to perform operations comprising: sending a second signal over the network to the second device to change the configuration of one or more operating parameters to the second device to cause the second device to generate one or more additional types of media stream, to stop generating one or more types of media stream, or both.

Item 20. The memory device of item 15, wherein to dynamically update the operating parameters of the second device to alter the one or more data streams the set of one or more first devices the memory further stores executable instructions for causing the processor to perform operations comprising: determining a device of the set of one or more first devices is capable of supporting a first type of media stream that the second device is capable of generating but is not currently being generating for the communication session; and determining, due to a bandwidth limitation, that the source device cannot provide the first type of media stream; determining that the first type of media stream can be generated from a second type of media stream currently being generated for the communication session; receiving the first type of media stream from the source device; generating the second type of media stream from the first type of media stream; and sending the second type of media stream to the device of the set of one or more first devices capable of supporting the first type of media stream.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a computer-readable medium storing executable instructions for causing the processor to perform operations comprising:
identifying, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices;
sending a first signal over a network to the second device to configure one or more operating parameters of the second device to generate the one or more data streams according to the capabilities of the set of one or more first devices; and
dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

2. The data processing system of claim 1, wherein to dynamically update the operating parameters of the second device in response to one or more new devices joining the communication session the computer-readable medium further stores executable instructions for causing the processor to perform operations comprising:
determining that the set of one or more third devices includes at least one device that has at least one capability to support at least one additional type of media stream that the second device is capable of generating for the communication session; and
configuring the one or more operating parameters of the second device to cause the second device to generate the at least one additional type of media stream.

3. The data processing system of claim 1, wherein to dynamically update the operating parameters of the second device in response to receiving an indication of changes in the capabilities of one or more devices of the set of one or more first devices the computer-readable medium further stores executable instructions for causing the processor to perform operations comprising:
determining that the set of one or more first devices includes at least one device that, due to a change in the capability of the at least one device, has at least one capability to support at least one additional type of media stream that the second device is capable of generating for the communication session; and
configuring the one or more operating parameters of the second device to cause the second device to generate the at least one additional type of media stream.

4. The data processing system of claim 1, wherein to dynamically update the operating parameters of the second device in response to receiving an indication of changes in the capabilities of one or more devices of the set of one or more first devices the computer-readable medium further stores executable instructions for causing the processor to perform operations comprising:
determining that none of the set of one or more first devices supports at least one type of media stream of the plurality of media streams being generated by the second device due to a change in capability of at least one device of the set of one or more first devices; and
configuring the one or more operating parameters of the second device to cause the second device to stop generating the at least one type of media stream not supported by the set of one or more first devices.

5. The data processing system of claim 1, wherein to dynamically update the operating parameters of the second device to alter the one or more data streams the set of one or more first devices the computer-readable medium further stores executable instructions for causing the processor to perform operations comprising:
sending a second signal over the network to the second device to change the configuration of one or more operating parameters to the second device to cause the second device to generate one or more additional types of media stream, to stop generating one or more types of media stream, or both.

6. The data processing system of claim 1, wherein to dynamically update the operating parameters of the second device to alter the one or more data streams the set of one or more first devices the computer-readable medium further stores executable instructions for causing the processor to perform operations comprising:
determining that a device of the set of one or more first devices is capable of supporting a first type of media stream that the second device is capable of generating but is not currently being generating for the communication session; and
determining, due to a bandwidth limitation, that the source device cannot provide the first type of media stream.

7. The data processing system of claim 6, wherein the computer-readable medium further stores executable instructions for causing the processor to perform operations comprising:
determining that the first type of media stream can be generated from a second type of media stream currently being generated for the communication session;
receiving the first type of media stream from the source device;
generating the second type of media stream from the first type of media stream; and
sending over the network the second type of media stream to the device of the set of one or more first devices capable of supporting the first type of media stream.

8. A method by a data processing system for conducting a communication session, the method comprising:
obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices;
sending a first signal over a network to the second device to configure one or more operating parameters of the second device to generate the one or more data streams according to the capabilities of the set of one or more first devices; and
dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

9. The method of claim 8, wherein dynamically updating the operating parameters of the second device in response to one or more new devices joining the communication session comprise:
determining that the set of one or more third devices includes at least one device that has at least one capability to support at least one additional type of media stream that the second device is capable of generating for the communication session; and
configuring the one or more operating parameters of the second device to cause the second device to generate the at least one additional type of media stream.

10. The method of claim 8, wherein dynamically updating the operating parameters of the second device in response to receiving an indication of changes in the capabilities of one or more devices of the set of one or more first devices:
determining that the set of one or more first devices includes at least one device that, due to a change in the capability of the at least one device, has at least one capability to support at least one additional type of media stream that the second device is capable of generating for the communication session; and
configuring the one or more operating parameters of the second device to cause the second device to generate the at least one additional type of media stream.

11. The method of claim 8, wherein dynamically updating the operating parameters of the second device in response to receiving an indication of changes in the capabilities of one or more devices of the set of one or more first devices:
determining that none of the set of one or more first devices supports at least one type of media stream of the plurality of media streams being generated by the second device due to a change in capability of at least one device of the set of one or more first devices; and
configuring the one or more operating parameters of the second device to cause the second device to stop generating the at least one type of media stream not supported by the set of one or more first devices.

12. The method of claim 8, wherein dynamically updating the operating parameters of the second device to alter the one or more data streams further comprises:
sending a second signal over the network to the second device to change the configuration of one or more operating parameters to the second device to cause the second device to generate one or more additional types of media stream, to stop generating one or more types of media stream, or both.

13. The method of claim 8, wherein dynamically updating the operating parameters of the second device to alter the one or more data streams further comprises:
determining that a device of the set of one or more first devices is capable of supporting a first type of media stream that the second device is capable of generating but is not currently being generating for the communication session; and
determining, due to a bandwidth limitation, that the source device cannot provide the first type of media stream.

14. The method of claim 13, further comprising:
determining that the first type of media stream can be generated from a second type of media stream currently being generated for the communication session;
receiving the first type of media stream from the source device;
generating the second type of media stream from the first type of media stream; and
sending over the network the second type of media stream to the device of the set of one or more first devices capable of supporting the first type of media stream.

15. A memory device storing instructions that, when executed on a processor of a computing device, cause the computing device to conduct a communication session, by:
obtaining, in connection to a communication session, capabilities of a set of one or more first devices configured to receive content associated with the communication session and a second device configured to provide content to the set of one or more first devices, the second device being configured to generate a plurality of data streams associated with the communication session for the set of one or more first devices;
sending a first signal over a network to the second device to configure one or more operating parameters of the second device to generate the one or more data streams according to the capabilities of the set of one or more first devices; and
dynamically updating the operating parameters of the second device to alter the one or more data streams generated by the second device in response to receiving an indication of changes in the capabilities of one or more devices of the set of one or more first devices, a set of one or more third devices joining the communication session having different capabilities than the first set of devices, or both.

16. The memory device of claim 15, wherein to dynamically update the operating parameters of the second device in response to one or more new devices joining the communication session the memory device further stores executable instructions for causing the processor to perform operations comprising:
determining that the set of one or more third devices includes at least one device that has at least one capability to support at least one additional type of media stream that the second device is capable of generating for the communication session; and
configuring the one or more operating parameters of the second device to cause the second device to generate the at least one additional type of media stream.

17. The memory device of claim 15, wherein to dynamically update the operating parameters of the second device in response to receiving an indication of changes in the capabilities of one or more devices of the set of one or more first devices the memory device further stores executable instructions for causing the processor to perform operations comprising:
determining that one or more devices of the set of first devices includes at least one device that, due to a change in the capability of the at least one device, has at least one capability to support at least one additional type of media stream that the second device is capable of generating for the communication session; and
configuring the one or more operating parameters of the second device to cause the second device to generate the at least one additional type of media stream.

18. The memory device of claim 15, wherein to dynamically update the operating parameters of the second device in response to receiving an indication of changes in the capabilities of one or more devices of the set of one or more first devices the memory device further stores executable instructions for causing the processor to perform operations comprising:
determining that none of the set of one or more first devices supports at least one type of media stream of the plurality of media streams being generated by the second device due to a change in capability of at least one device of the set of one or more first devices; and
configuring the one or more operating parameters of the second device to cause the second device to stop generating the at least one type of media stream not supported by the set of one or more first devices.

19. The memory device of claim 15, wherein to dynamically update the operating parameters of the second device to alter the one or more data streams the set of one or more first devices the memory device further stores executable instructions for causing the processor to perform operations comprising:
sending a second signal over the network to the second device to change the configuration of one or more operating parameters to the second device to cause the second device to generate one or more additional types of media stream, to stop generating one or more types of media stream, or both.

20. The memory device of claim 15, wherein to dynamically update the operating parameters of the second device to alter the one or more data streams the set of one or more first devices the memory further stores executable instructions for causing the processor to perform operations comprising:
determining a device of the set of one or more first devices is capable of supporting a first type of media stream that the second device is capable of generating but is not currently being generating for the communication session;
determining, due to a bandwidth limitation, that the source device cannot provide the first type of media stream;
determining that the first type of media stream can be generated from a second type of media stream currently being generated for the communication session;
receiving the first type of media stream from the source device; and
generating the second type of media stream from the first type of media stream; and
sending the second type of media stream to the device of the set of one or more first devices capable of supporting the first type of media stream.
